(19) United States
(12) Patent Application Publication
(10) Pub. No.: US 2025/0044146 A1
(43) Pub. Date: Feb. 6, 2025

(54) TILT COMPENSATION APPARATUS AND TILT COMPENSATION METHOD THEREFOR

(71) Applicants: Mettler-Toledo (Changzhou) Precision Instruments Ltd., Changzhou (CN); Mettler-Toledo (Changzhou) Measurement Technology Ltd., Changzhou (CN); Mettler-Toledo International Trading (Shanghai) Co., Ltd., Shanghai (CN)

(72) Inventors: Jianwei Wu, Changzhou (CN); Hongzhi Lin, Changzhou (CN); Chao Fang, Changzhou (CN); Jifeng Wang, Changzhou (CN)

(21) Appl. No.: 18/716,405

(22) PCT Filed: Dec. 8, 2022
(86) PCT No.: PCT/CN2022/137455

§ 371 Date: Jun. 4, 2024

(30) Foreign Application Priority Data
Dec. 10, 2021 (CN) 202111504899.7

(51) Int. Cl. G01G 23/01; G01G 3/14; G01G 19/02

(52) U.S. Cl. CPC G01G 23/01; G01G 3/1414; G01G 19/021

(57) ABSTRACT

The present disclosures relate generally to a tilt compensation apparatus and a tilt compensation method therefor. The tilt compensation method includes: S1: performing tilt angle calibration and horizontal rotation angle calibration on a weighing system; S2: selecting to set different specified tilt angles and different specified horizontal rotation angles, and measuring weights, tilt angles, and horizontal rotation angles under different loads; S3: calculating a weight compensation value based on the set specified tilt angles and the set specified horizontal rotation angles as well as the weights, tilt angles, and horizontal rotation angles obtained through measurement; and S4: calculating an actual weighing weight based on an actual measured weight of the weighing system and the weight compensation value. These disclosures provide more, accurate tilt compensation for weighing systems having a column-type load cell.

### TECHNICAL FIELD

The present invention relates to the field of dynamic weighing technologies, and in particular, to a tilt compensation apparatus and a tilt compensation method therefor.

### BACKGROUND ART

Column-type digital load cells are widely used in vehicle weighing scales, axle load scales, platform scales, large tank scales, and other application scenarios. These application scenarios all belong to multi-point application, where one weighing system is equipped with three, four, eight, or multiple number of column-type load cells. The column-type load cells are connected through a CAN, an RS485, or other type of bus connectors to a terminal, and the terminal displays weight data of the weighing system to users. Before initiating normal operation of the load cell for a particular application, the terminal performs addressing, zero-point and sensitivity calibration of the load cell, and adjusts the angle difference, and then the load cell can perform normal weighing.

In addition to transmitting a weight signal to the terminal, each column-type load cell transmits other characteristic signals, such as temperature, humidity, gas concentration, and tilt angle signals to the terminal for display, and the user can monitor the environment and status of the column-type load cell based on these information.

The weighing system may eventually provide inaccurate results due to improper status of the column-type load cell such as not being in a vertical state in a process after being installed on a vehicle weight scale, the column-type load cell is tilted in an application process due to a status change (tilting) of the column-type load cell or a large day and night temperature difference (the foundation and the weighing platform have different dilatation coefficients), the column-type load cell is tilted due to settlement of the foundation after long-term use of the weighing system, etc.

Large tank scales also perform inaccurate weighing due to the tilting of the column-type load cell during installation or use.

In the existing technical solutions, a current tilt angle of the load cell can be obtained by using an accelerometer or a tilt angle sensor, and then an algorithm is designed to correct a weight error caused by the tilting, so that the weighing accuracy can be maintained even in a tilted state. For example, the solutions disclosed in the Chinese application for patent CN 102778287 A are only applicable to horizontal tilt of commercial scales, and this technology is not applicable to the application of a vehicle scale on which a digital load cell is vertically installed. The algorithms and methods mentioned in this patent application are only applicable to tilt compensation for beam-type load cells, and are not applicable to column-type load cells where the application scenarios are more complex and severe.

### SUMMARY OF INVENTION

In view of the above problems in the prior art, the present invention proposes a tilt compensation apparatus and a tilt compensation method therefor, which can provide accurate tilt compensation for a weighing system.

Specifically, the present invention proposes a tilt compensation method applicable to a weighing system having a column-type load cell, including the steps of:
S1: performing a tilt angle calibration and a horizontal rotation angle calibration on the column-type load cell of the weighing system.
S2: aligning the column-type load cell according to a specified tilt angle and a specified horizontal rotation angle, and measuring a weight, a tilt angle, and a horizontal rotation angle under load.

In other words, the column-type load cell is tilted in a specific manner, in particular a specific manner that is given by the specified tilt angle and the specified horizontal rotation angle, and a weighing value, a tilt angle and a horizontal rotation angle is measured for a load, this means when a load is applied on the column-type load cell aligned (tilted) according to the specified tilt angle and the specified horizontal rotation angle.

The applied load may be zero load. However, in embodiments, S2 comprises measuring weights, tilt angles, and horizontal rotation angles under different loads, wherein at least one load is not zero.

The specified tilt angle and the specified horizontal rotation angle may be specified in the sense that they are selected to put the column-type load cell in combination with the applied load in a specific state, in particular a state that is favorable for assessing the influence of misalignment (tilt). For example, the specified tilt angle and the specified horizontal rotation angle may be specified in combination with the applied load in the sense that they are selected to obtain, this means to cause the measurement of, a specific weight value, a specific tilt angle, and a specific horizontal rotation angle.

In many embodiments and applications, it is not sufficient to align the column-type load cell according to one specified tilt angle and one specified horizontal rotation angle, and measuring weight, tilt angle, and horizontal rotation angle under one load or different loads. Rather, S2 comprises in many embodiments aligning the column-type load cell according to different specified tilt angles and different specified horizontal rotation angles, and measuring weights, tilt angles, and horizontal rotation angles under different loads.

In such embodiments, the different specified tilt angles, the different specified horizontal rotation angles, and the different loads may be selected such that an equal distribution of measurement configurations is generated. Examples of specified tilt angles, specified horizontal rotation angles and loads that lead to an equal distribution of measurement configurations are given further below.
S3: calculating a weight compensation value based on the specified tilt angle or, as the case may be, specified tilt angles, and the specified horizontal rotation angle, or, as the case may by, specified horizontal rotation angles, as well as the measured weight(s), tilt angle(s), and horizontal rotation angle(s).

In embodiments, in which S2 comprises aligning the column-type load cell according to different specified tilt angles and different specified horizontal rotation angles, and measuring weights, tilt angles, and horizontal rotation angles under different loads, S3 comprises aligning the column-type load cell according to the different specified tilt angles and the different specified horizontal rotation angles, applying the different loads to each of these alignments and measuring weight, tilt angle, and horizontal rotation angle for each of the resulting configurations.

In other words, the weight, tilt angle, and horizontal rotation angle is measured for each alignment of the column-type load cell and for each load.
S4: calculating an actual, this means compensated, weighing weight based on an actual measured weight of the weighing system and the weight compensation value.

According to an embodiment of the present invention, in step S1, the tilt angle calibration is performed by using an accelerometer or a tilt angle sensor, and the horizontal rotation angle calibration is performed using a magnetometer.

According to an embodiment of the present invention, in step S1, the tilt angle calibration is performed by using an accelerometer and performing the tilt angle calibration by using the accelerometer includes the steps of:

T1: obtaining three-axis acceleration outputs Aₓ₀, A_{y0}, and A_{z0}, and calculating spherical coordinates θ, φ, and ø, of a current alignment (“tilt state”) using the following equation:

$$θ = {tan}^{- 1} ( \frac{{A}_{Y 0}}{\sqrt{{A}_{X 0}^{2} + {A}_{Z 0}^{2}}} ) ;$$

$$φ = {tan}^{- 1} ( \frac{{A}_{X 0}}{\sqrt{{A}_{Y 0}^{2} + {A}_{Z 0}^{2}}} ) ;$$

$$ϕ = {tan}^{- 1} ( \frac{\sqrt{{A}_{Y 0}^{2} + {A}_{X 0}^{2}}}{{A}_{Z 0}} ) ;$$

T2: calculating a rotation matrix by substituting θ, φ, and ø in the following equation:

$$M = ( \begin{matrix}cos ϕ & sin ϕ & 0 \\ - sin ϕ & cos ϕ & 0 \\ 0 & 0 & 1\end{matrix} ) ( \begin{matrix}cos φ & 0 & - sin φ \\ 0 & 1 & 0 \\ sin φ & 0 & cos φ\end{matrix} ) ( \begin{matrix}1 & 0 & 0 \\ 0 & cos θ & sin θ \\ 0 & - sin θ & cos θ\end{matrix} ) ;$$

T3: multiplying the obtained three-axis acceleration outputs Aₓ, A_{y}, and A_{z} by the rotation matrix to obtain three-axis acceleration outputs A′ₓ, A′_{Y}, and A′_{z} in an geodetic coordinate system;

$$( \begin{matrix}{A}_{X}^{′} \\ {A}_{Y}^{′} \\ {A}_{Z}^{′}\end{matrix} ) = M * ( \begin{matrix}{A}_{X} \\ {A}_{Y} \\ {A}_{Z}\end{matrix} ) ;$$

and

T4: calculating a roll value, a pitch value, and a yaw value based on the three-axis acceleration outputs A′ₓ, A′_{y}, and A′_{z}.

According to an embodiment of the present invention, S2 comprises aligning the column-type load cell according to different specified tilt angles and different specified horizontal rotation angles, wherein the specified tilt angles are 0°, 1°, 2°, and 3°, the specified horizontal rotation angles are 0°, 90°, 180°, and 270°, and the applied loads are zero, ½ full load, and full load. As mentioned above, the weight value, tilt angle, and horizontal rotation angle may then be measured for each alignment of the column-type load call and for each load, for example by traversing through the different configurations to obtain the corresponding weights, tilt angles, and horizontal rotation angles.

According to an embodiment of the present invention, in step S3, the weight compensation value includes a tilt error compensation value E1 and a rotation angle error compensation value E2, and the calculation formula used is:

$${E}_{1} = \frac{{a}_{1} * ( 1 + cos r )}{cos r + {c}_{1} * k * ( 1 - cos r )} + \frac{{a}_{2} * ( 1 + cos p )}{cos p + {c}_{2} * k * ( 1 - cos p )} ;$$

$${E}_{2} = ( {b}_{0} - {b}_{1} * sin ϑ + {b}_{2} * sin {ϑ}^{2} ) ;$$

where r denotes a roll value, p denotes a pitch value, δ denotes a horizontal rotation angle, a₁ and c₁ denote distribution coefficients of the roll value, a₂ and c₂ denote distribution coefficients of the pitch value, k denotes a structural coefficient of the column-type load cell, and b₀, b₁, b₂ denote rotation angle error compensation values.

According to an embodiment of the present invention, a calculation formula for the compensated weighing weight is:

$${W}_{c} = \frac{W + {E}_{2}}{1 + {E}_{1} / {10}^{6}} ;$$

where W_{c} denotes the compensated weighing weight, and W denotes the actual measured weight.

According to an embodiment of the present invention, before step S4 is performed, the weight compensation value is verified.

The present invention further provides a tilt compensation apparatus applicable to a weighing system having a column-type load cell, including:
A calibration module configured to perform a tilt angle calibration and a horizontal rotation angle calibration on the column-type load cell of the weighing system to obtain calibration data, such as a rotation matrix M.
A test module configured for selecting, in particular by a user, a set specified tilt angle and a set specified horizontal rotation angle, and for obtaining a weight, tilt angle, and horizontal rotation angle measured under load.

In other words, the test module is configured to select a specified tilt angle and a specified horizontal rotation angle, wherein the column-type load cell is aligned (tilt) according to this specified tilt angle and this specified horizontal rotation angle.

Additionally, the test module may be configured to select the load applied to the column-type load cell.
A compensation value calculation module configured for calculating a weight compensation value based on the weight, tilt angle, and horizontal rotation angle obtained by the test module.
A weighing calculation module configured for calculating an actual weighing weight, this means a compensated weight value, based on an actual measured weight of the weighing system and the weight compensation value.

According to an embodiment, the test module is configured for selecting different set specified tilt angles and different set specified horizontal rotation angles and for obtaining weights, tilt angles, and horizontal rotation angles measured under different loads.

In particular, the test module may be configured to select the specified tilt angles 0°, 1°, 2°, and 3°, the specified horizontal rotation angles 0°, 90°, 180°, and 270°, and the loads zero, ½ full load, and full load.

In an embodiment, the test module is configured to select a set specified tilt angle, a set specified horizontal rotation angle, and a set load, to obtain a weight, a tilt angle, and a horizontal rotation angle, and to traverse all the specified tilt angles, specified horizontal rotation angles, and loads to obtain the corresponding weights, tilt angles, and horizontal rotation angles.

In other words, the test module is configured to transverse all selected or selectable tilt angles, horizontal rotation angles, and loads to obtain the corresponding weights, tilt angles, and horizontal rotation angles.

According to an embodiment of the present invention, the tilt compensation apparatus further includes a verification module configured to verify the weight compensation value calculated by the compensation value calculation module.

According to the tilt compensation apparatus and the tilt compensation method therefor provided in the present invention, the actual measured weight is corrected based on the obtained weight compensation value, thereby providing accurate tilt compensation for the weighing system.

It should be understood that the above general description and the following detailed description of the present invention are both exemplary and illustrative, and are intended to provide further explanations for the present invention.

### BRIEF DESCRIPTION OF DRAWINGS

The accompanying drawings are included to provide a further understanding of the present invention and are incorporated in and constitute a part of the present application, show the embodiments of the present invention, and serve together with the description, explain the principles of the present invention. In the accompanying drawings:

FIG. 1 is a flowchart of a tilt compensation method according to an embodiment of the present invention

FIG. 2 is a schematic structural diagram of a tilt compensation apparatus according to an embodiment of the present invention

### DESCRIPTION OF EMBODIMENT

It should be noted that, in the case of no conflict, the embodiments and the features thereof in the present application can be combined with each other.

The technical solutions of the present application will be clearly and completely described below in conjunction with the drawings in the embodiments of the present application. Apparently, the described embodiments are merely some rather than all the embodiments of the present application. The following description of at least one exemplary embodiment is merely illustrative, and in no way serves as any limitation on the present application and application or use thereof. All other embodiments derived by those of ordinary skill in the art based on the embodiments of the present application without creative efforts fall within the protection scope of the present application. It should be noted that the terms used herein are merely for describing specific implementations and are not intended to limit the exemplary implementations according to the present application. As used herein, unless the context clearly indicates otherwise, the singular forms are intended to include the plural forms as well. Moreover, it should also be understood that when the terms “include(s)” and/or “comprise(s)” are used in the description, it indicates the presence of features, steps, operations, devices, components, and/or combinations thereof.

Unless specifically stated otherwise, the relative arrangement of components and steps, numerical expressions and numerical values set forth in these embodiments do not limit the scope of the present application. In addition, it should be understood that for ease of description, the sizes of various parts shown in the drawings are not drawn to scale. The technologies, methods, and devices known to those of ordinary skill in the related art may not be discussed in detail, but where appropriate, the technologies, methods, and devices should be regarded as part of the authorization specification. In all examples shown and discussed here, any specific value should be interpreted as merely exemplary and not as limiting. Therefore, other examples of the exemplary embodiment may have different values. It should be noted that similar reference signs and letters refer to similar items in the following drawings. Therefore, once a specific item is defined in one of the drawings, it need not be further discussed in subsequent drawings.

In the description of the present application, it should be understood that an orientation or position relationship indicated by orientation terms such as “front, rear, upper, lower, left, and right”, “transverse, longitudinal, vertical, and horizontal”, and “top and bottom” is usually based on an orientation or position relationship shown in the drawings, which is only for the convenience of describing the present application and simplifying the description. Unless otherwise stated, these orientation terms do not indicate or imply that an apparatus or element referred to must have a specific orientation or be constructed and operated in a specific orientation, so that the orientation terms cannot be understood as a limitation of the protection scope of the present application; and the orientation terms “inner and outer” refer to the inside and outside relative to the contour of each component itself.

For convenience of description, spatially relative terms such as “on”, “above”, “on the top surface”, and “upper” can be used herein to describe a spatial position relationship between a device or a feature shown in the figure and other devices or features. It should be understood that spatially relative terms are intended to include different orientations in use or operation in addition to the orientation of the device described in the figure. For example, if the device in the figure is inverted, the device described as “on other devices or structures” or “above other devices or structures” will then be positioned as “under other devices or structures” or “below other devices or structures”. Therefore, the exemplary term “above” may include two orientations “above” and “below”. The device may also be positioned in other different manners (rotated by 90 degrees or in other orientations), and spatially relative description used here is explained accordingly.

In addition, it should be noted that the use of words such as “first” and “second” to define parts is merely for the convenience of distinguishing between corresponding parts. Unless otherwise stated, the above words have no special meaning and therefore cannot be understood as limitation of the protection scope of the present application. Furthermore, although the terms used in the present application are selected from well-known common terms, some of the terms mentioned in the specification of the present application may have been selected by the applicant according to his or her determination, and the detailed meaning thereof is described in the relevant section herein. Furthermore, the present application must be understood, not simply by the actual terms used but also by the meanings encompassed by each term.

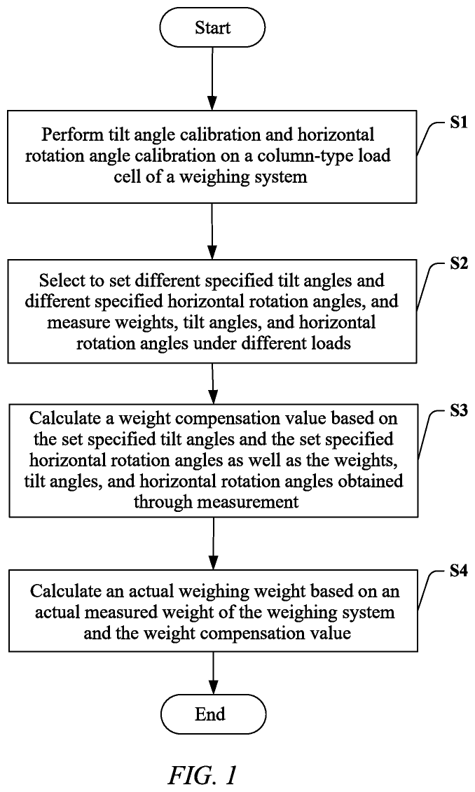

FIG. 1 is a flowchart of a tilt compensation method according to an embodiment of the present invention. As shown in the figure, the tilt compensation method for a weighing system having a column-type load cell, including the steps of:
S1: performing a tilt angle calibration and a horizontal rotation angle calibration on a column-type load cell of a weighing system, where a tilt angle is used to represent an included angle formed between a length direction and a gravitational acceleration direction of the column-type load cell, and a horizontal rotation angle is used to represent a rotation angle of the column-type load cell around the gravitational acceleration direction;
S2: selecting a specific set of tilt angles and a specific set of horizontal rotation angles to set the weighing system at the specific set of tilt angles and the specific set of horizontal rotation angles, and performing measurement to obtain a corresponding set of weight values, tilt angle values, and horizontal rotation angle values under different set of loads;
S3: calculating a weight compensation value based on the specific set of tilt angles and the specific set of horizontal rotation angles, and the corresponding set of weight values, tilt angle values, and horizontal rotation angle values obtained through measurement; and
S4: calculating a compensated weighing weight based on an actual measured weight of the weighing system and the weight compensation value.

Preferably, in step S1, the tilt angle calibration is performed by using an accelerometer or a tilt angle sensor, and the horizontal rotation angle calibration is performed by using a magnetometer. A three-axis accelerometer or a two-axis or three-axis tilt angle sensor may be selected as the accelerometer. A two-axis magnetic sensor may be selected as the magnetometer and used with a magnet. The magnet is installed on an inner side of the column-type load cell. The accelerometer, tilt angle sensor, and magnetometer may be designed as independent modules to be installed inside or outside of the column-type load cell, or may be integrated onto the mainboard of the column-type load cell in an integrated design manner.

Preferably, the step of performing the tilt angle calibration by using an accelerometer includes steps of:
T1: obtaining three-axis acceleration outputs Aₓ₀, A_{y0}, and A_{z0}, and calculating θ, φ, and ø using the following equation. For the tilt angle calibration, X-, Y-, and Z-axis origin coordinates (Aₓ₀, A_{y0}, A_{z0}) of output accelerations of the column-type load cell in a vertical state are first obtained, then the included angle θ between the horizontal plane and the X axis is calculated, the angle φ between the horizontal plane and the Y axis is calculated, and the angle ø between a gravity vector and the Z axis is calculated, where θ represents a pitch angle, φ represents a roll angle, and ø represents a yaw angle.

$$θ = {tan}^{- 1} ( \frac{{A}_{Y 0}}{\sqrt{{A}_{X 0}^{2} + {A}_{Z 0}^{2}}} ) ;$$

$$φ = {tan}^{- 1} ( \frac{{A}_{X 0}}{\sqrt{{A}_{Y 0}^{2} + {A}_{Z 0}^{2}}} ) ;$$

$$ϕ = {tan}^{- 1} ( \frac{\sqrt{{A}_{Y 0}^{2} + {A}_{X 0}^{2}}}{{A}_{Z 0}} ) ;$$

T2: calculating a rotation matrix. The rotation matrix is a matrix that, when multiplied by a vector, has the effect of changing the direction of the vector but not changing the size and maintaining chirality. The rotation matrix does not include point inversion, which may change the chirality, that is, change the right-handed coordinate system to the left-handed coordinate system or vice versa. Rotation may be divided into active rotation and passive rotation. Active rotation is counterclockwise rotation of the vector about the rotation axis. Passive rotation is counterclockwise rotation of the coordinate axis itself, which is equivalent to an inverse operation of the active rotation.

$$M = ( \begin{matrix}cos ϕ & sin ϕ & 0 \\ - sin ϕ & cos ϕ & 0 \\ 0 & 0 & 1\end{matrix} ) ( \begin{matrix}cos φ & 0 & - sin φ \\ 0 & 1 & 0 \\ sin φ & 0 & cos φ\end{matrix} ) ( \begin{matrix}1 & 0 & 0 \\ 0 & cos θ & sin θ \\ 0 & - sin θ & cos θ\end{matrix} ) ;$$

T3: multiplying the obtained three-axis acceleration outputs Aₓ, A_{y}, and A_{z} by the rotation matrix to obtain three-axis acceleration outputs A′ₓ. A′_{Y}, and A′_{z} in an actual coordinate system, that is, the current coordinate system is converted into the system coordinate system (geodetic coordinate system) by the rotation matrix.

$$( \begin{matrix}{A}_{X}^{′} \\ {A}_{Y}^{′} \\ {A}_{Z}^{′}\end{matrix} ) = M * ( \begin{matrix}{A}_{X} \\ {A}_{Y} \\ {A}_{Z}\end{matrix} ) ;$$

T4: calculating a roll value, a pitch value, and a yaw value based on the three-axis acceleration outputs A′ₓ A′_{y}, and A′_{z}.

Preferably, in step S2, setting the weighing system at the specific set of tilt angles such as 0°, 1°, 2°, and 3°, and at the specific set of horizontal rotation angles such as0°, 90°, 180°, and 270°, and performing measurement under different set of loads such as a zero load, a half load, and a full load; where; it is easy to understand that the column-type load cell is fully loaded when it enters a working state in which it has a rated voltage and has a rated current flowing through it; and obtaining the corresponding set of weight values, tilt angle values, and horizontal rotation angle values.

It should be noted that, as an example rather than a limitation, the specific set of tilt angles selected may alternatively be 0°, 1.5°, and 3°, or other values which is optional. Similarly, the specific set of horizontal rotation angles selected may alternatively be 0°, 60°, 120°, 180°, 240°, and 300°. The loads selected may be zero, a one-third of full load, a two-thirds of full load, and a full load. According to actual requirements, more optional values for the specific set of tilt angles, horizontal rotation angles and different loads may be selected.

Preferably, in step S3, the weight compensation value includes a tilt error compensation value E1 and a rotation angle error compensation value E2, and a calculation formula used is:

$${E}_{1} = \frac{{a}_{1} * ( 1 + cos r )}{cos r + {c}_{1} * k * ( 1 - cos r )} + \frac{{a}_{2} * ( 1 + cos p )}{cos p + {c}_{2} * k * ( 1 - cos p )} ;$$

$${E}_{2} = ( {b}_{0} - {b}_{1} * sin ϑ + {b}_{2} * sin {ϑ}^{2} ) ;$$

where r denotes a roll value, p denotes a pitch value, δ denotes a horizontal rotation angle, a₁ and c₁ denote distribution coefficients of the roll value, a₂ and c₂ denote distribution coefficients of the pitch value, k denotes a structural coefficient of the column-type load cell, and b₀, b₁, b₂ denote rotation angle error compensation values. The rotation angle error compensation values b₀, b₁, b₂ are obtained by fitting, using the least square method, the weight and horizontal rotation angle obtained in step S2.

Preferably, a calculation formula for the compensated weighing weight is:

$${W}_{c} = \frac{W + {E}_{2}}{1 + {E}_{1} / {10}^{6}} ;$$

where W_{c} denotes the compensated weighing weight, and W denotes the actual measured weight.

Preferably, before step S4 is performed, the weight compensation value is verified. It is verified whether the actual weighing weight is within a tolerance range of the set accuracy by tilting the column-type load cell vertically by any angle within 3° (a range defined in R76 regulations), then rotating horizontally by any angle, and loading any weight.

Preferably, when a status of the tilt angle of the column-type load cell exceeds a set threshold range (for example, by a tilt angle of 3°), the weighing system does not perform a tilt compensation, that is, the weighing system does not perform a compensated weighing weight calculation, but gives alarm information and the specific tilt angle values and rotation directions of the column-type load cell to prompt a user, such that the user can quickly and accurately adjust the status of the column-type load cell to a set compensation range. When a tilt angle of the column-type load cell is within a set range of 0° to 3°, the weighing system automatically performs tilt compensation to ensure the accuracy requirements of the column-type load cell and the performance accuracy of the weighing system.

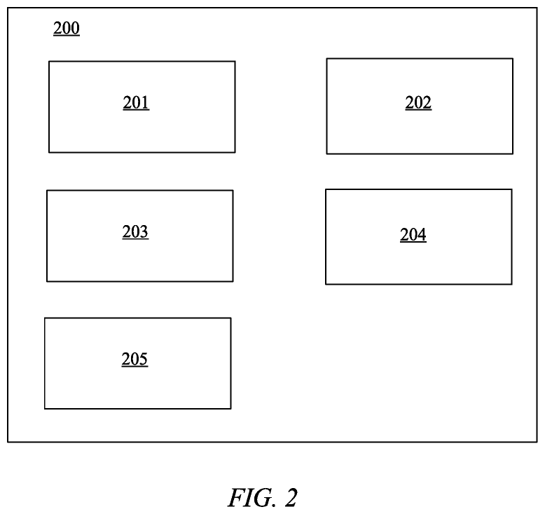

FIG. 2 is a schematic structural diagram of a tilt compensation apparatus according to an embodiment of the present invention. As shown in the figure, the present invention further provides a tilt compensation apparatus 200 applicable to a weighing system having a column-type load cell. The tilt compensation apparatus 200 includes:
a calibration module 201 configured to perform a tilt angle calibration and a horizontal rotation angle calibration on the weighing system to obtain calibration data;
a test module 202 for selecting and setting the weighing system at a specific set of tilt angles and a specific set of horizontal rotation angles, and obtaining a corresponding set of weight values, tilt angle values, and horizontal rotation angle values under different set of loads through measurement;
a compensation value calculation module 203 calculating a weight compensation value based on the corresponding set of weight values, tilt angle values, and horizontal rotation angle values obtained by the test module 202; and
a weighing calculation module 204 calculating a compensated weighing weight based on an actual measured weight of the weighing system and the weight compensation value.

Preferably, in the test module 202, the specific set of tilt angles are set to 0°, 1°, 2°, and 3°, the specific set of horizontal rotation angles are set to 0°, 90°, 180°, and 270°, and the different set of loads are set to a zero load, a half load, and a full load. All the specific set of tilt angles, the specific set of horizontal rotation angles, and different set loads are set and measurements are performed to obtain the corresponding weight values, tilt angle values, and horizontal rotation angle values.

Preferably, in the calibration module 201, the tilt angle calibration is performed by using an accelerometer or a till angle sensor, and the horizontal rotation angle calibration is performed by using a magnetometer.

Preferably, the tilt compensation apparatus 200 further includes a verification module 205 configured to verify the weight compensation value calculated by the compensation value calculation module 203. It is verified whether the actual weighing weight is within a tolerance range of the set accuracy by tilting the column-type load cell vertically by any angle within 3° (a range defined in R76 regulations), then rotating horizontally by any angle, and loading any weight.

According to the tilt compensation apparatus and the tilt compensation method therefor provided in the present invention, a current three-dimensional status of the column-type load cell is obtained based on the tilt angle and the horizontal rotation angle, so that service personnel can accurately and quickly locate the correct status in which the column-type load cell is to be installed, thereby ensuring the perfectly perpendicular installation and helping to ensure the accuracy of the weighing system. In addition, the status, vibration direction, motion trajectory, etc. of all column-type load cells in an application process (for different vehicles, different weights, different weighing methods, etc.) can be achieved in real time, so that an effect of tilt compensation can be better detected, and a basis for fault diagnosis can be provided or researches on multi-point weighing technologies can be performed smoothly.

The present invention further provides a computer-readable storage medium, which is a non-volatile storage medium or a non-transitory storage medium and has stored thereon computer instructions, where when the computer instructions are run, the steps corresponding to any one of the foregoing tilt compensation methods are implemented, which will not be repeated herein.

The present invention further provides a weighing system, including a memory and a processor, where the memory has stored thereon computer instructions capable of being run on the processor, and when running the computer instructions, the processor implements the steps of any one of the foregoing tilt compensation methods.

Some aspects of the tilt compensation method of the present invention may be completely executed by hardware, or may be completely executed by software (including firmware, resident software, microcode, etc.), or may be executed by a combination of hardware and software. The hardware or software described above may all be referred to as “data block”, “module”, “engine”, “unit”, “component”, or “system”. The processor may be one or more application-specific integrated circuits (ASIC), digital signal processors (DSP), digital signal processing devices (DSPD), programmable logic devices (PLD), field-programmable gate arrays (FPGA), processors, controllers, microcontrollers, microprocessors, or a combination thereof. In addition, various aspects of the present application may be embodied as a computer product in one or more computer-readable media, and the product includes computer-readable program code. For example, the computer-readable media may include, but are not limited to, a magnetic storage device (for example, a hard disk, a floppy disk, a tape, etc.), an optical disc (for example, a compact disc (CD), a digital versatile disc (DVD), etc.), a smart card, and a flash memory device (for example, a card, a stick, a key drive, etc.).

The computer-readable medium may include a propagation data signal containing computer program code, for example, on a baseband or as a part of a carrier. The propagation signal may take various forms, including an electromagnetic form, an optical form, etc., or a suitable combination form. The computer-readable medium may be any computer-readable medium other than a computer-readable storage medium. The medium may be connected to an instruction execution system, apparatus, or device to implement communication, propagation, or transmission of a program for use. The program code located on the computer-readable medium can be propagated through any suitable medium, including radio, a cable, a fibre-optic cable, a radio frequency signal, or a similar medium, or any combination of the foregoing media.

In addition, unless explicitly stated in the claims, the order of processing elements and sequences, the use of numbers and letters, or the use of other names in the present application are not intended to limit the order of the procedures and methods of the present application. Some of the embodiments of the present invention that are currently considered useful have been discussed in the foregoing disclosure by various examples. However, it should be understood that such details are merely for the purpose of illustration, and the appended claims are not limited to the disclosed embodiments but are intended to encompass all modifications and equivalent combinations that comply with the essence and scope of the embodiments of the present application. For example, although the system components described above can be implemented by hardware devices, they can also be implemented purely by software solutions, for example, installing the described system on an existing server or mobile device.

Similarly, it should be noted that, to simplify the disclosure of the present application to facilitate the understanding of one or more embodiments of the present application, in the foregoing description of the embodiments of the present application, various features may be sometimes incorporated into one embodiment, drawing, or the description thereof. However, such a method disclosed does not mean that the subject of the present application requires more features than those mentioned in the claims. In fact, the features of the embodiments are fewer than all the features of a single embodiment disclosed above.

In some embodiments, numbers for describing the number of compositions and attributes are used. It should be understood that such numbers used in the description of the embodiments are modified by the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the specification and claims are approximate values, and the approximate values can be changed according to the required characteristics of individual embodiments. In some embodiments, for the numerical parameters, the specified significant digits should be taken into consideration and a general digit reservation method should be used. Although the numerical ranges and parameters used to confirm the breadth of the ranges of the numerical parameters in some embodiments of the present application are approximate values, such numerical values need to be set as precisely as possible within a feasible range in specific embodiments.

It can be apparent for a person skilled in the art that various modifications and variations may be made to the exemplary embodiments of the present invention without departing from the spirit and scope of the present invention. Therefore, it is intended that the present invention covers the modifications and variations of the present invention that fall within the scope of the appended claims and their equivalents.

### REFERENCE SIGNS LIST

The drawings include the following reference numerals:
200 Tilt compensation apparatus
201 Calibration module
202 Test module
203 Compensation value calculation module
204 Weighing calculation module
205 Verification module

1. A tilt compensation method applicable to a weighing system having a column-type load cell, said method comprising the steps of:
S1: performing tilt angle calibration and horizontal rotation angle calibration on the column-type load cell of the weighing system;
S2: selecting to set different specified tilt angles and different specified horizontal rotation angles, and measuring weights, tilt angles, and horizontal rotation angles under different loads;
S3: calculating a weight compensation value based on the set specified tilt angles and the set specified horizontal rotation angles as well as the weights, tilt angles, and horizontal rotation angles obtained through measurement; and
S4: calculating an actual weighing weight based on an actual measured weight of the weighing system and the weight compensation value.

2. The tilt compensation method according to claim 1, wherein: in step S1, the tilt angle calibration is performed by using an accelerometer or a tilt angle sensor, and the horizontal rotation angle calibration is performed by using a magnetometer.

3. The tilt compensation method according to claim 2, wherein: the step of performing the tilt angle calibration by using an accelerometer comprises:
T1: collecting three-axis acceleration outputs Aₓ₀, A_{y0}, and A_{z0}, and calculating θ, φ, and ø in a current state:
$$θ = {tan}^{- 1} ( \frac{{A}_{Y 0}}{\sqrt{{A}_{X 0}^{2} + {A}_{Z 0}^{2}}} ) ;$$
$$φ = {tan}^{- 1} ( \frac{{A}_{X 0}}{\sqrt{{A}_{Y 0}^{2} + {A}_{Z 0}^{2}}} ) ;$$
$$ϕ = {tan}^{- 1} ( \frac{\sqrt{{A}_{Y 0}^{2} + {A}_{X 0}^{2}}}{{A}_{Z 0}} ) ;$$
T2: calculating a rotation matrix:
$$M = ( \begin{matrix}cos ϕ & sin ϕ & 0 \\ - sin ϕ & cos ϕ & 0 \\ 0 & 0 & 1\end{matrix} ) ( \begin{matrix}cos φ & 0 & - sin φ \\ 0 & 1 & 0 \\ sin φ & 0 & cos φ\end{matrix} ) ( \begin{matrix}1 & 0 & 0 \\ 0 & cos θ & sin θ \\ 0 & - sin θ & cos θ\end{matrix} ) ;$$
T3: multiplying the collected three-axis acceleration outputs by the rotation matrix to obtain three-axis acceleration outputs A′ₓ, A′_{y}, and A′_{z} in an actual coordinate system;
$$( \begin{matrix}{A}_{X}^{′} \\ {A}_{Y}^{′} \\ {A}_{Z}^{′}\end{matrix} ) = M * ( \begin{matrix}{A}_{X} \\ {A}_{Y} \\ {A}_{Z}\end{matrix} ) ;$$
and
T4: calculating a roll value, a pitch value, and a yaw value based on the three-axis acceleration outputs A′ₓ, A′_{y}, and A′_{z}.

4. The tilt compensation method according to claim 1, wherein; in step S2, the specified tilt angles are set to 0°, 1°, 2°, and 3°, the specified horizontal rotation angles are set to 0°, 90°, 180°, and 270°, and the loads are set to zero, a ½ full load, and a full load; and
a specified tilt angle, a specified horizontal rotation angle, and a set load are selected to obtain a weight, a tilt angle, and a horizontal rotation angle, and all the specified tilt angles, specified horizontal rotation angles, and set loads are traversed to obtain the corresponding weights, tilt angles, and horizontal rotation angles.

5. The tilt compensation method according to claim 1, wherein: in step S3, the weight compensation value comprises a tilt error compensation value E1 and a rotation angle error compensation value E2, and a calculation formula is:
$${E}_{1} = \frac{{a}_{1} * ( 1 + cos r )}{cos r + {c}_{1} * k * ( 1 - cos r )} + \frac{{a}_{2} * ( 1 + cos p )}{cos p + {c}_{2} * k * ( 1 - cos p )} ;$$
$${E}_{2} = ( {b}_{0} - {b}_{1} * sin ϑ + {b}_{2} * sin {ϑ}^{2} ) ;$$
where r denotes a roll value, p denotes a pitch value, δ denotes a horizontal rotation angle, a₁ and c₁ denote distribution coefficients of the roll value, a₂ and c₂ denote distribution coefficients of the pitch value, k denotes a structural coefficient of the load cell, and b₀, b₁, b₂ denote rotation angle error compensation values.

6. The tilt compensation method according to claim 5, wherein: a calculation formula for the actual weighing weight is:
$${W}_{c} = \frac{W + {E}_{2}}{1 + {E}_{1} / {10}^{6}} ;$$
where W_{c} denotes the actual weighing weight, and W denotes the actual measured weight.

7. The tilt compensation method according to claim 1, wherein: before step S4 is performed, the weight compensation value is verified.

8. A tilt compensation apparatus applicable to a weighing system having a column-type load cell, said lift compensation apparatus comprising:
a calibration module configured to perform tilt angle calibration and horizontal rotation angle calibration on the column-type load cell of the weighing system to obtain calibration data;
a test module selecting to set different specified tilt angles and different specified horizontal rotation angles, and obtaining weights, tilt angles, and horizontal rotation angles under different loads through measurement;
a compensation value calculation module calculating a weight compensation value based on the weights, tilt angles, and horizontal rotation angles obtained by the test module; and
a weighing calculation module calculating an actual weighing weight based on an actual measured weight of the weighing system and the weight compensation value.

9. The tilt compensation apparatus according to claim 8, wherein; in the test module, the specified tilt angles are set to 0°, 1°, 2°, and 3°, the specified horizontal rotation angles are set to 0°, 90°, 180°, and 270°, and the loads are set to zero, a ½ full load, and a full load; and
a specified tilt angle, a specified horizontal rotation angle, and a set load are selected to obtain a weight, a tilt angle, and a horizontal rotation angle, and all the specified tilt angles, specified horizontal rotation angles, and set loads are traversed to obtain the corresponding weights, tilt angles, and horizontal rotation angles.

10. The tilt compensation apparatus according to claim 8, further comprising: a verification module configured to verify the weight compensation value calculated by the compensation value calculation module.
